(19) United States
(12) Patent Application Publication
(10) Pub. No.: US 2026/0141615 A1
(43) Pub. Date: May 21, 2026

(54) NON-LINEAR PROJECTION OF VOLUMETRIC PARTICLE REPRESENTATIONS FOR RENDERING NOVEL VIEWS

(71) Applicant: Nvidia Corporation, Santa Clara, CA (US)

(72) Inventors: Janick Martine Esturo, Munich (DE); Qi Wu, Santa Clara, CA (US); Nicolas Moenne-Loccoz, Mount-Royal, CA (US); Sanja Fidle, Toronto (CA); Zan Gojcic, Zurich (CH)

(21) Appl. No.: 19/358,930

(22) Filed: Oct. 15, 2025

Related U.S. Application Data
(60) Provisional application No. 63/721,021, filed on Nov. 15, 2024.

(51) Int. Cl. G06T 15/08; G06T 15/06

(52) U.S. Cl. CPC G06T 15/08; G06T 15/06; G06T 2200/04

(57) ABSTRACT

Approaches presented herein provide for the support of distorted cameras in 3D scene reconstruction. Objects in a scene can be represented by 3D Gaussian particles. To determine which 3D Gaussian particles contribute to individual pixels of an image to be rendered, an unscented transform-based approach can be used to project representative sigma points for the 3D Gaussian particles onto a 2D camera plane. The 3D Gaussian particles determined to potentially contribute to a given pixel can then have rays traced to determine a segment of intersection of the ray across a 3D Gaussian particle, and a value corresponding to the point of maximum response across that segment can be returned as a contribution value. The various contribution values for each pixel can then be blended to provide an output color value.

### CROSS-REFERENCE TO RELATED APPLICATIONS

This application claims priority to U.S. Provisional Patent Application No. 63/721,021, filed Nov. 15, 2024, and entitled “Generalizing 3D Gaussian Splatting to Non-Linear Complex Camera Models,” which is hereby incorporated herein in its entirety and for all purposes.

### BACKGROUND

In various applications—such as for animation or video generation—there is a need to generate an accurate reconstruction of a given scene or 3D environment. This can include multi-view 3D reconstruction with the ability to generate image data from novel views or camera positions that were not represented in the initial set of input views. While there are various approaches to generating such representations, volumetric particle-based approaches such as three-dimensional Gaussian splatting (3DGS) have gained significant popularity due to their high visual fidelity and fast rendering speeds. Using 3DGS, scenes can be modeled as an unstructured collection of fuzzy 3D Gaussian particles, each defined by its location, scale, rotation, opacity, and appearance, which can be rendered differentiably in real time via a technique such as rasterization. Reliance on rasterization imposes some limitations, however, as existing splatting formulations do not support highly-distorted cameras with complex time-dependent effects such as rolling shutter. Additionally, rasterization cannot simulate secondary rays required for representing phenomena like reflection, refraction, and shadows. A process such as ray tracing can be used to render volumetric particles instead, which can help to mitigate shortcomings of rasterization, but it does so at the expense of significantly reduced rendering speed, even when the tracing formulation is heavily optimized for semi-transparent particles. Further, projecting 3D Gaussian particles onto a camera image plane using existing splatting formulations often leads to approximation errors, even for perfect pinhole cameras, which become progressively worse with increasing distortion.

### BRIEF DESCRIPTION OF THE DRAWINGS

Various embodiments in accordance with the present disclosure will be described with reference to the drawings, in which:

FIGS. 1A and 1B illustrate example images captured by cameras without, and with, distortion, which can be processed according to at least one embodiment;

FIG. 2A illustrates an example approach to projecting a 3D Gaussian particle onto a 2D image plane, according to at least one embodiment;

FIG. 2B illustrates an example approach to determining a maximum response along a segment of intersection of a 3D Gaussian particle for a given pixel region, according to at least one embodiment;

FIG. 3 illustrates components of an example system that can be used to render a novel view image for a scene using 3D Gaussian particles, according to at least one embodiment;

FIG. 4 illustrates an image that can be rendered using secondary rays for reflections and refractions, according to at least one embodiment;

FIG. 5A illustrates an example process that can be performed to determine 3D Gaussian particles that likely contribute to each of a plurality of pixel regions of an image to be rendered, according to at least one embodiment;

FIG. 5B illustrates an example process that can be performed to determine pixel values for an image to be rendered based on the 3D Gaussian particles determined to potentially contribute to each pixel region, according to at least one embodiment;

FIGS. 6A and 6B illustrate components of an example content generation system, according to at least one embodiment;

FIG. 7 illustrates components of a distributed system that can be utilized to generate and provide image content, including generating mesh representations of one or more objects, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments; and

FIG. 12 illustrates at least portions of a graphics processor, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for 3D assets, generative AI, cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), etc., systems for performing generative AI operations (e.g., using one or more language models, transformer models, etc.), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with various illustrative embodiments can provide for real-time rendering of images for complex scenes using potentially limited-capacity hardware. A process such as three-dimensional (3D) Gaussian splatting can be used in such a rendering process, but is typically limited in applicability to perfect pinhole camera models as it assumes a linear projection function that can project 3D particles (or Gaussians) into the camera image plane. Approaches in accordance with various embodiments allow 3D Gaussian splatting to be used with non-linear, complex camera models. Instead of directly projecting the 3D (volumetric) particles, a set of representative “sigma” points can be sampled in the source domain and then projected into the target domain (or onto a 2D camera plane) with a non-linear projection function, according to an unscented transform. These points can be used to re-estimate (or generate an approximation of) the 3D particles in the target domain. Such an approach allows for the avoidance of linearization issues, as projection of the infinitesimal points can use an arbitrary projection function and therefore can be used to represent arbitrary camera models. In at least one embodiment, such a process can be performed to determine which 3D Gaussian particles impact (or contribute to) a given pixel of an image to be rendered from a given point of view. Once these contributing particles are determined, non-linear projection (e.g., ray projection or tracing) can be performed with respect to the contributing Gaussian particles for a given pixel in order to determine the maximum response value for each Gaussian particle as intersected by the projected ray. The color values corresponding to the maximum response values for each 3D Gaussian particle intersecting a ray projected for a given pixel can be blended to arrive at an output color value for that pixel. These output color values can then be used to render the image using a rasterization or other such image generation process or pipeline. A rasterization formulation as used in such a process can approximate the 3D Gaussian particles rather than approximating the non-linear projection function, which allows for support of complex time-dependent effects such as rolling shutter. Such a process also generates representations that can be used with different image generation processes, such as rasterization and ray tracing, which helps to support phenomena such as refraction and reflections in the images to be rendered. Such a process can provide comparable rendering rates and image fidelity to other imaging techniques, while offering greater flexibility and outperforming dedicated methods on datasets with distorted cameras.

Variations of this and other such functionality can be used as well within the scope of the various embodiments, as would be apparent to one of ordinary skill in the art in light of the teachings and suggestions contained herein.

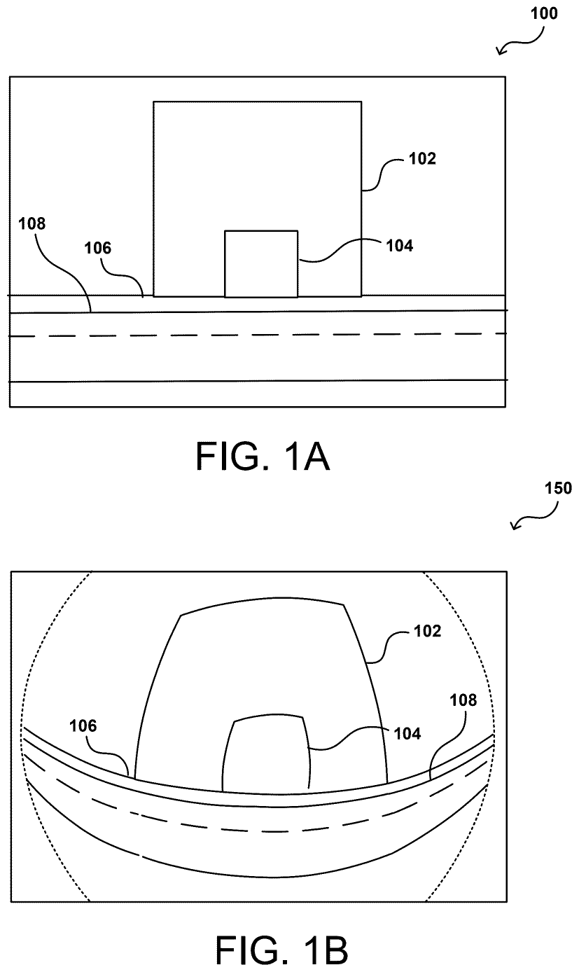

FIG. 1A illustrates an example image 100 captured for a scene, or a set of one or more objects in an environment. The objects include, for example, a building 102 with a door 104, a sidewalk 106, and a roadway, as might be found in any given town. The image 100 represents an “ideal” image, such as one captured with a perfect pinhole camera. The image includes no distortions or artifacts due to the camera, with all edges of the objects being straight and not having any distortion in size, shape, or scale. Unfortunately, most modern cameras are not ideal cameras and come with some amount of distortion or non-linearity. FIG. 1B illustrates an example image 150 of the same scene captured using a camera with a fisheye lens, although various other types of distortion-inducing aspects (e.g., rolling shutter) may be present in such a camera as well. While this image 150 represents more severe fisheye effects than would be noticed in many conventional cameras, many cameras have lenses that generate at least some amount of such distortion, particularly for objects near the edges of a captured (or generated) image. In order to generate a reconstruction of a scene in the presence of such a camera or lens (or lens assembly, etc.), an image generation process can attempt to account for these and other such distortions and non-linearities, in order to generate an accurate and/or realistic image.

Prior approaches to performing scene reconstruction have used techniques such as 3D Gaussian Splatting (3DGS), which has been observed to provide for efficient reconstruction and high-fidelity real-time rendering of complex scenes on consumer hardware. However, due to its rasterization-based formulation, 3DGS is constrained to “ideal” cameras, such as pinhole cameras that do not exhibit distortion or imaging artifacts and produce images such as that illustrated in FIG. 1A. Further, techniques such as 3DGS typically lack support for secondary lighting effects, which may be due to reflections or refractions. While it may be possible to address at least some of these limitations by tracing volumetric particles instead, such an approach comes at the cost of significantly slower rendering speeds.

Approaches in accordance with at least one embodiment can instead use a transform, such as a 3D Gaussian Unscented Transform (3DGUT). Such an unscented transform can be used in place of, for example, an elliptical weighted average (EWA) splatting formulation used in 3DGS. An unscented transform can be used to approximate 3D elliptical volumetric (e.g., Gaussian) particles through the use of approximation points, referred to herein as “sigma” points. These 3D elliptical volumetric particles will be referred to as 3D Gaussian particles herein for simplicity. The “sigma” points can be selected using factors such as location and covariance, as discussed in more detail later herein. Signa points can be precisely projected under any appropriate non-linear projection function, such as by using an unscented transform. The use of such an unscented transform can allow for support of various distorted cameras, including those with time-dependent effects such as rolling shutter, while retaining the efficiency of rasterization. Further, a rendering formulation can be aligned with those of tracing-based methods, allowing secondary ray tracing to be used to represent phenomena such as reflections and refraction within the same 3D representation.

Volumetric particle-based representations, such as those generated using 3D Gaussian splatting, have gained significant popularity due in part to their high visual fidelity and fast rendering speeds. 3DGS can be used to model a scene as an unstructured collection of “fuzzy” 3D Gaussian particles, each defined by its location, scale, rotation, opacity, and appearance. These particles can be rendered differentiably in real time via rasterization, for example, allowing their parameters to be optimized through a re-rendering loss function. High frame-rates of 3DGS, especially when compared to volumetric ray marching methods, can be largely accredited to the efficient rasterization of particles. However, this reliance on rasterization also imposes some inherent limitations. The EWA splatting formulation does not support highly-distorted cameras with complex time-dependent effects such as rolling shutter, which produces images such as the example image 150 illustrated in FIG. 1B. Additionally, rasterization cannot simulate secondary rays required for representing phenomena like reflection, refraction, and shadows. Instead of rasterization, volumetric particles can be rendered using a technique such as ray tracing. While such an approach can help to mitigate the shortcomings of rasterization, it does so at the expense of significantly reduced rendering speed, even when the tracing formulation is heavily optimized for semi-transparent particles. Conventional approaches for 3DGS may be ill-suited to represent distorted cameras and rolling shutter, for example, as typical 3DGS implementations rely on an EWA splatting formulation that requires computing the Jacobian of the non-linear projection function in order to project 3D Gaussian particles onto a camera image plane. This leads to approximation errors, even for perfect pinhole cameras, and the errors become progressively worse with increasing distortion. Moreover, it is unclear that time-dependent effects, such as rolling shutter, can be represented accurately within an EWA splatting process.

Approaches in accordance with various embodiments can overcome at least some of these and other such limitations in prior reconstruction approaches. Such limitations can be overcome while remaining in the realm of rasterization, thereby maintaining higher rendering rates. As mentioned, this can include use of an unscented transform instead of approximating a non-linear projection function. An unscented transform can be used where 3D Gaussian particles are approximated using a set of carefully-selected sigma points (or representative sample points). These sigma points can be projected exactly onto the camera image plane by, for example, applying an arbitrarily complex projection function to each point, after which a 2D Gaussian can be re-estimated from the projected points in the form of an unscented transform (UT). Apart from a better approximation quality, an unscented transform is derivative-free and avoids the need to derive the Jacobians for different camera models. Moreover, complex effects such as rolling shutter distortions can directly be represented by transforming each sigma point with a different extrinsic matrix.

In at least one embodiment, a rasterization rendering formulation can be aligned with a ray tracing formulation. Rendering formulations mainly differ in terms of: (i) determining which particles contribute to which pixels, (ii) the order in which the particles are intersected, and (iii) how the particles are evaluated. To align the representations, the Gaussian particle response can be followed in three dimensions, and sorted in order. While small differences may persist, such an approach can provide a representation that can be both rasterized and ray-traced, supporting secondary rays that may be used to simulate phenomena such as refraction and reflection. As mentioned, a UT can be used advantageously to approximate the distribution of the random variable using a set of sigma points that can be transformed exactly (or at least with high accuracy), after which they can be used to re-estimate the statistics of the random variable in the target domain.

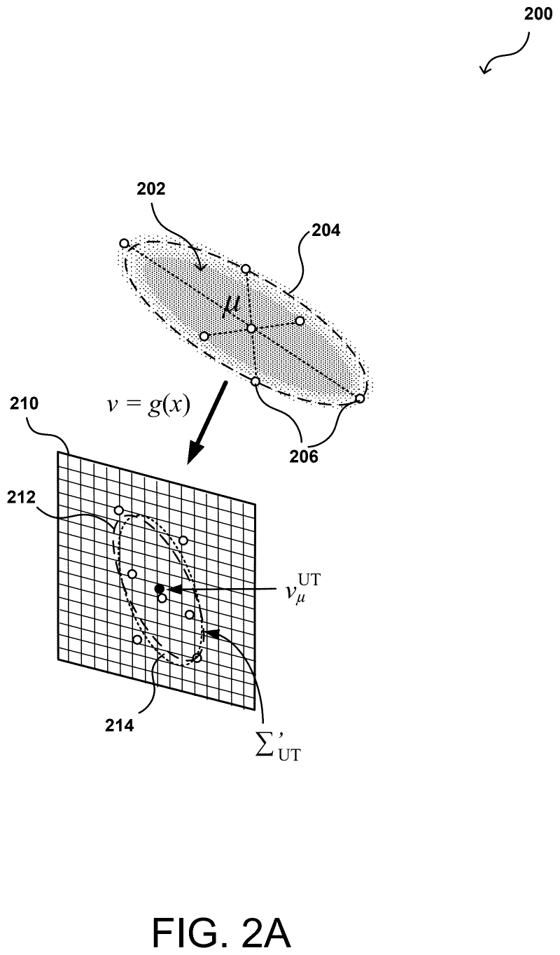

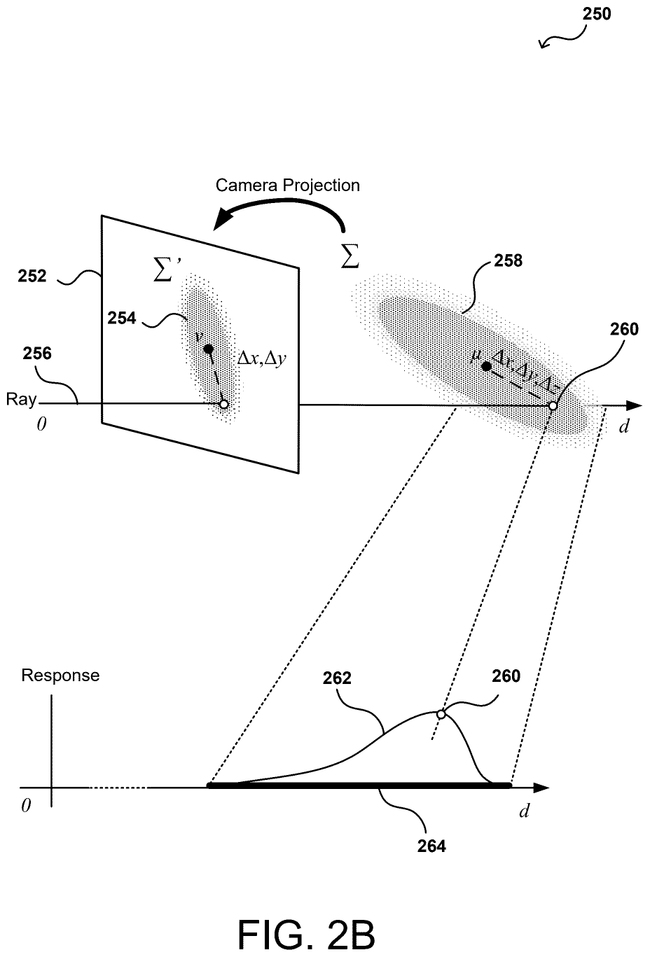

FIG. 2A illustrates an example view 200 of an unscented transform-based approach being used to project a 3D Gaussian particle 202 onto a 2D camera plane, according to at least one embodiment. As known for 3D Gaussian splatting or other such projection techniques, a transform function can be used to project a camera position-appropriate view of a 3D Gaussian particle 202 (or other such representation of an object in a scene) onto a 2D camera plane 210. In this example, a properly projected outer boundary approximation 212 for the 3D Gaussian particle is illustrated on the 2D camera plane 210, which corresponds to an outer boundary 204 of the 3D Gaussian particle 202. As mentioned, when a camera is used that demonstrates distortions or non-linearities, the projections generated by processes such as Monte Carlo sampling or linearization (e.g., EWA) can be unacceptably inaccurate as they do not properly account for the non-linearities due to the distortions. As illustrated in FIG. 2A, however, a projection (illustrated by a representative outline approximation 214) performed using an unscented transform can be relatively (or at least) acceptably accurate for a wide variety of distortions and non-linearities. As illustrated, a set of sigma points 206 can be used for the projection to reduce compute cost and improve efficiency. The projected sigma points can serve as an approximation of the projected 3D Gaussian particle. A benefit to such an approach is that it can be used to determine, with relative accuracy, which regions (e.g., pixels or tiles) of an image are (at least potentially) impacted by a given 3D Gaussian particle 202. A pixel region may be considered to be impacted by a 3D Gaussian particle if the approximation of the particle, as determined using the projected sigma points, at least partially intersects or is included within the bounds of a given pixel region of an image to be rendered based in part on the current point of view of a virtual camera to be used to render the image. Prior approaches do not provide such accurate projections, and thus are likely to improperly identify the appropriate regions impacted by a given particle, which can result in image artifacts or other lower quality image aspects.

In at least one embodiment, a scene (or collection of one or more 3D objects) can be represented using an unordered set of 3D Gaussian particles whose response function ρ: [symbol] ³→ [symbol] can be given by:

$$ρ ( x ) = exp ( - \frac{1}{2} {( x - μ )}^{T} {Σ}^{- 1} ( x - μ ) ) \qquad ( 1 )$$

where μ∈ [symbol] ³ denotes the particle's position and Σ∈ [symbol] ^{3×3} its covariance matrix. To ensure that Σ remains positive semi-definite during gradient-based optimization, it can be decomposed into a rotation matrix R∈SO(3) and a scaling matrix S∈ [symbol] ^{3×3}, such that

$$Σ = R S {S}^{T} {R}^{T} \qquad ( 2 )$$

In practice, both R and S can be stored as vectors-a quaternion q∈ [symbol] ⁴ for the rotation and a vector s∈ [symbol] ³ for the scaling. Each particle can also be associated with an opacity coefficient, σ∈ [symbol] , and a view-dependent parametric radiance function φ_{β}(d): [symbol] ³→ [symbol] ³, with d the incident ray direction, which is in practice represented using spherical harmonics functions of order m=3.

Within a 3DGS rasterization framework, the 3D particles first need to be projected to the 2D camera image plane 210 in order to determine their contributions to the individual pixels. To this end, 3DGS follows and computes a covariance matrix Σ_{c}∈ [symbol] ^{2×2} for a projected Gaussian in image coordinates via first-order approximation as:

$${Σ}^{′} = {J}_{[ : 2 , : 3 ]} W Σ {W}^{T} {J}_{[ : 2 , : 3 ]}^{T} \qquad ( 3 )$$

where W∈SE(3) transforms the particle from the world to the camera coordinate system, and J∈ [symbol] ^{3×3} denotes the Jacobian matrix of the affine approximation of the projective transformation, which is obtained by considering the linear terms of its Taylor expansion. The Gaussian response of a particle i for a position x∈ [symbol] ³ can then be computed in 2D from its projection on the image plane vₓ∈ [symbol] ² as

$${ρ}_{i} ( x ) = exp ( - \frac{1}{2} {( {ν}_{x} - {ν}_{{μ}_{i}} )}^{T} {Σ}_{i}^{′ - 1} ( {ν}_{x} - {ν}_{{μ}_{i}} ) ) \qquad ( 4 )$$

where v_{μ}_{ᵢ}∈ [symbol] ² denotes the projected mean of the particle.

When rendering a 3D Gaussian particle 202, the color c∈ [symbol] ³ of a camera ray r(τ)=o+τd with origin o∈ [symbol] ³ and direction d∈ [symbol] ³ can be rendered from the above volumetric particle representation using numerical integration

$$c ( o , d ) = {\sum }_{i = 1}^{N} {c}_{i} ( d ) {α}_{i} {\prod }_{j = 1}^{i - 1} 1 - {α}_{j} , \qquad ( 5 )$$

where N denotes the number of particles that contribute to the given ray and opacity αᵢ∈ [symbol] is defined as αᵢ=σᵢρᵢ(o+τd) for any τ∈ [symbol] ⁺.

Approaches in accordance with various embodiments can provide a formulation that accommodates highly-distorted cameras and time-dependent camera effects, such as a rolling shutter effect. Such a formulation can also unify a rendering formulation to allow the same reconstructions to be rendered using either splatting or tracing, allowing for hybrid rendering with traced secondary rays, all while preserving the efficiency of rasterization. As mentioned, an EWA splatting formulation used in 3DGS for projecting 3D Gaussian particles onto the camera image plane relies on the linearization of the affine approximation of the projective transform (Eq. (3)). Such an approach, however, has several notable limitations: (i) it neglects higher-order terms in the Taylor expansion, leading to projection errors even with perfect pinhole cameras, and these errors increase with camera distortion; (ii) it requires deriving a new Jacobian for each specific camera model (e.g., the equidistant fisheye model in), which is cumbersome and error prone; and (iii) it necessitates representing the projection as a single function, which is particularly challenging when accounting for time-dependent effects such as rolling shutter.

To overcome these limitations, an unscented transform can be used to approximate volumetric particles using a set of carefully selected sigma points 206, as illustrated in FIG. 2A. Specifically, a 3D Gaussian scene representation can be considered as described herein, where particles are characterized by their position μ and covariance matrix Σ. The sigma points

$$𝒳 = {\{ {x}_{i} \}}_{i = 0}^{6}$$

can then be defined as:

$${x}_{i} = \{ \begin{matrix}μ & for i = 0 \\ μ + {\sqrt{( 3 + λ ) {Σ}^{2}}}_{[ i ]} & for i = 1 , 2 , 3 \\ μ - {\sqrt{( 3 + λ ) Σ}}_{[ i - 3 ]} & for i = 4 , 5 , 6\end{matrix} \qquad ( 6 )$$

and their corresponding weights

$$𝒲 = {\{ {w}_{i} \}}_{i = 0}^{6}$$

as

$${w}_{i}^{μ} = \{ \begin{matrix}\frac{λ}{3 + λ} & for i = 0 \\ \frac{1}{2 ( 3 + λ )} & for i = 1 , … , 6\end{matrix} \qquad ( 7 )$$

$${w}_{i}^{Σ} = \{ \begin{matrix}\frac{λ}{3 + λ} + ( 1 - {α}^{2} + β ) & for i = 0 \\ \frac{1}{2 ( 3 + λ )} & for i = 1 , … , 6\end{matrix} \qquad ( 8 )$$

where λ=α²(3+κ)−3, α is a hyperparameter that controls the spread of the points around the mean, κ is a scaling parameter typically set to 0, and β is used to incorporate prior knowledge about the distribution.

Each sigma point can be independently projected onto the 2D camera image plane 210 using a non-linear projection function, such as vₓ_{ᵢ}=g(xᵢ). The 2D conic can subsequently be approximated as the weighted posterior sample mean and covariance matrix of the Gaussian, as may be given by:

$${ν}_{μ} = {\sum }_{i = 0}^{6} {w}_{i}^{μ} {ν}_{{x}_{i}} \qquad ( 9 )$$

$${Σ}^{′} = {\sum }_{i = 0}^{6} {w}_{i}^{Σ} ( {ν}_{{x}_{i}} - {ν}_{μ} ) {( {ν}_{{x}_{i}} - {ν}_{μ} )}^{T} \qquad ( 10 )$$

With the 2D conic computed, tiling and culling procedures can be applied to determine which particles influence which pixels (or pixel regions). A particle response evaluation as disclosed herein does not depend on the 2D conic, as an unscented transform can instead act as an acceleration structure to efficiently determine the particles that contribute to each pixel (or tile, etc.), avoiding a need to compute a backward pass through the non-linear projection function.

Once the Gaussian particles (at least potentially) contributing to each pixel have been identified, the response for those particles can be evaluated. FIG. 2B illustrates a view 250 of an example evaluation of a 3D Gaussian particle 258 that can be performed according to at least one embodiment. In this example, a 3D Gaussian particle 258 can be evaluated directly in 3D to determine a single sample 260 located at the point of maximum particle response along a given ray 256. As illustrated in FIG. 2B, a ray 256 can be traced (or projected) through a 3D Gaussian particle 258. While the projection 254 of the 3D Gaussian particle 258 on a 2D camera plane 252 is illustrated, the transform used to determine the projection can be non-linear. In this example, the projected ray 256 will intersect the 3D Gaussian particle 258 over a span of the particle, forming a segment 264 of intersection. A segment, as used herein, will include at least one sample point, but more often will have a length based on a distance of intersection of a ray with the 3D Gaussian particle. Because the particle is Gaussian, there will be a Gaussian function response 262 along the length of that segment 264 of intersection. The response can be evaluated over the length of that segment, and the sample point 260 corresponding to the maximum response over the length of that segment value can be returned for use in determining the appropriate color value for the pixel for which the ray was traced. That ray (as well as any secondary or other relevant rays) may intersect multiple such particles, and the maximum response values for each of those particles can be determined and used to calculate a final color value for the respective pixel.

In a 3D response evaluation approach, such as is illustrated in FIG. 2B, a distance τₘₐₓ=argmax_{τ}ρ(o+τd) can be computed, which maximizes the particle response along the ray r(t), as may be given by:

$${τ}_{max} = \frac{{( μ - o )}^{T} {Σ}^{- 1} d}{{d}^{T} {Σ}^{- 1} d} = \frac{- {o}_{g}^{T} {d}_{g}}{{d}_{g}^{T} {d}_{g}} \qquad ( 11 )$$

where o_{g}=S⁻¹R^{T}(o−μ) and d_{g}=S⁻¹R^{T}d. Unlike 3DGS, which performs particle evaluations in 2D, such an approach can avoid propagating gradients through the projection function, thereby avoiding the approximations and mitigating potential numerical instabilities.

A volumetric rendering formulation as disclosed herein, including both rendering equation Eq. (5) and particle evaluation Eq. (11), can be at least somewhat similar to the formulation used in 3DGRT, as it allows for collection of the hit particles in their exact τₘₐₓ order along the ray thanks to a dedicated acceleration structure. A technique such as 3DGS, however, can sort these particles globally for each tile. In order to obtain a better approximation of the τₘₐₓ order for at least some techniques disclosed herein, a multi-layer alpha blending (MLAB) approximation can be used. An MLAB approximation can involve storing the per-ray k-farthest hit particles (for a value such as k=16) in a buffer. The closest hits which cannot be stored in the buffer can be incrementally alpha-blended until the transmittance of the blended part vanishes.

As an alternative, a hybrid transparency (HT) blending strategy can be used for splatting Gaussian particles. Instead of storing the k-farthest hit particles and incrementally blending the closest hits, an HT-based strategy can store the k closest hit particles, and incrementally blend the farthest hits. Such an approach allows for recovery of the exact k-closest hit particles, but can involve analysis of all such particles, which may be prohibitively slow without dedicated optimizations and heuristics, etc.

As mentioned, such approaches can be used advantageously for scene reconstruction, supporting the ability to perform novel view synthesis for 3D scenes. Such approaches also support a variety of applications and techniques that were previously unattainable with particle scene representation within a rasterization framework. As mentioned, this can include support for distorted camera models. Projection of particles using an unscented transform allows 3DGUT to not only be trained for distorted cameras, but also to render different camera models with varying distortion from scenes that were trained using perfect pinhole camera inputs. Such approaches can also support cameras with a rolling shutter effect. Apart from the modeling of distorted cameras, 3DGUT can also faithfully incorporate camera motion into the projection formulation, hence supporting time-dependent camera effects, such as rolling shutter, which are commonly encountered in fields such as autonomous driving and robotics. Although at least some amount of optical distortion can be addressed with image rectification, incorporating time-dependency of the projection function in the linearization framework is highly non-trivial.

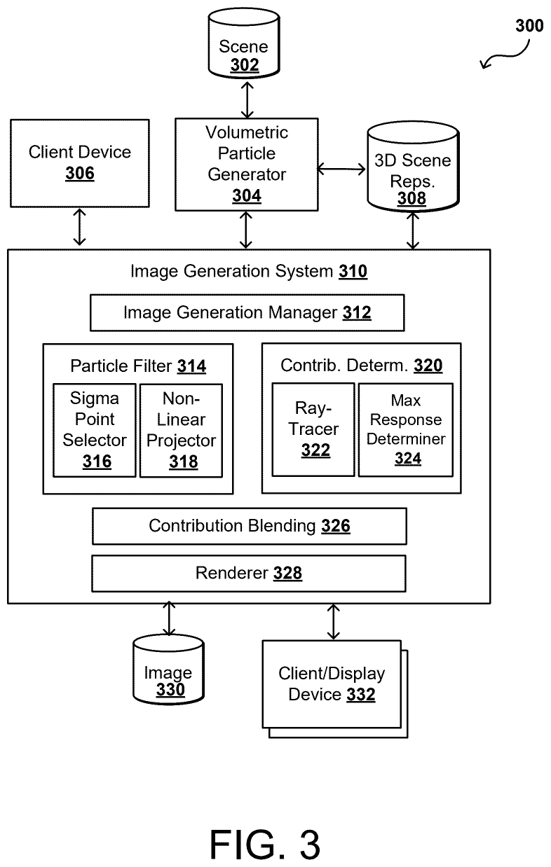

FIG. 3 illustrates components of an example system 300 that can be used to perform scene reconstruction according to at least one embodiment. In this example, there can be a set of scene data stored to a scene repository 302 or other such location. This may include generated assets, captured sensor data, or other such representations of objects in a scene. In this example system 300, the scene data can be analyzed using a volumetric particle generator 304 to generate a set of 3D Gaussian particles to represent the objects in the scene. If image or sensor data were captured for the scene, the images or sensor data would likely correspond to only a limited set of views, and the 3D Gaussian particles can be generated to provide 3D representations of the objects in the images or sensor data, allowing for generation of novel view images corresponding to points of view that were not in the captured image or sensor data set. These 3D Gaussian particles can then be stored to a 3D scene representation repository 308 or other such location.

A user might determine to generate an image of a scene from a given point of view. The user may enter this input into a client device 306 to be provided to an image generation system 310. The image generation system in this example is provided using one or more remote computing resources, such as shared or “cloud” resources in a datacenter or server farm, but could also be at least partially executed or hosted on the client device or other such computing resources. The image generation system 310 can include an image generation manager 312, such as an application running on a cloud server, which can analyze the instructions from the client device 306 and locate the appropriate 3D scene representations from the appropriate repository 308. It should be understood that instructions to render an image or video sequence may come from applications, processes, services, or other systems as well in accordance with various embodiments. In this example, the image generation manager 312 can work with a particle filter 314, a contribution determination component 320, a contribution blending component 326, and a renderer 328, which can each comprise a combination of hardware and software. In some embodiments, the functionality of at least some of these components may be offered by a single component (or additional or alternative components) as well.

As mentioned, generating an image reconstruction of a scene from 3D Gaussian particle representations can involve determining which 3D Gaussian particles contribute to each pixel of the image, then evaluating those contributions to determine a final color value (or other pixel value) for each pixel, tile, or other such region of an image. In this example, the 3D Gaussian particles are first analyzed using a particle filter 314. A particle filter 314 evaluates the 3D Gaussian particles with respect to each individual pixel of an image, to determine which 3D Gaussian particles are likely to contribute to that pixel, effectively “filtering” out the 3D Gaussian particles that are unlikely to contribute, which can help to improve efficiency and reduce unnecessary processing. The example particle filter 314 in FIG. 3 includes a sigma point selector 316 which can select a representative set of sigma points for each 3D Gaussian particle, as may be a function of aspects such as position and covariance. The selected sigma points can then be provided to a non-linear projector 318, which can use an unscented transform-based approach to project the sigma points for each 3D Gaussian particle onto a 2D camera plane, to determine which 3D Gaussian particles potentially contribute to each pixel, and/or to determine the pixel values to which each Gaussian particle contributes. The output of the particle filter 314 can then be a list or set of 3D Gaussian particles that are determined to potentially contribute to each pixel region of an image to be rendered, based in part on the sigma point-based projections.

Once the contributing 3D Gaussian particles are determined, the list or set can be provided as input to a contribution determination component 320. The contribution determination component can be tasked with determining a value, if any, which each contributing 3D Gaussian particle contributes to that pixel region. In this example system, this includes using a ray-tracer 322 (or other such projection mechanism) to use a non-linear tracing algorithm to trace rays from each pixel region according to the selected point of view for the image. The traced ray will impact at least some of the 3D Gaussian particles that were determined to potentially contribute to the respective pixel region, and in many instances will have a segment of intersection across the 3D Gaussian particle. The Gaussian function for the 3D Gaussian particle can be evaluated over this segment of intersection using a maximum response determiner 324. The maximum response along that segment can be determined, and the associated color value returned that corresponds to that point of maximum response. These color values can be returned for each intersected 3D Gaussian particle for each individual pixel. The color values can then be evaluated using a contribution blending component 326, which can use any of the blending techniques discussed or suggested herein, or otherwise appropriate, to blend the color values determined from the points of maximum response. These blended (output) color values can then be provided to a renderer 328, or components of a rendering pipeline, to perform and/or complete generation of the image for the scene. The generated image can then be returned to the initiating client device 306, stored to an image repository 330 (or other such data storage), and/or provided to a different client and/or display device 332, among other such options.

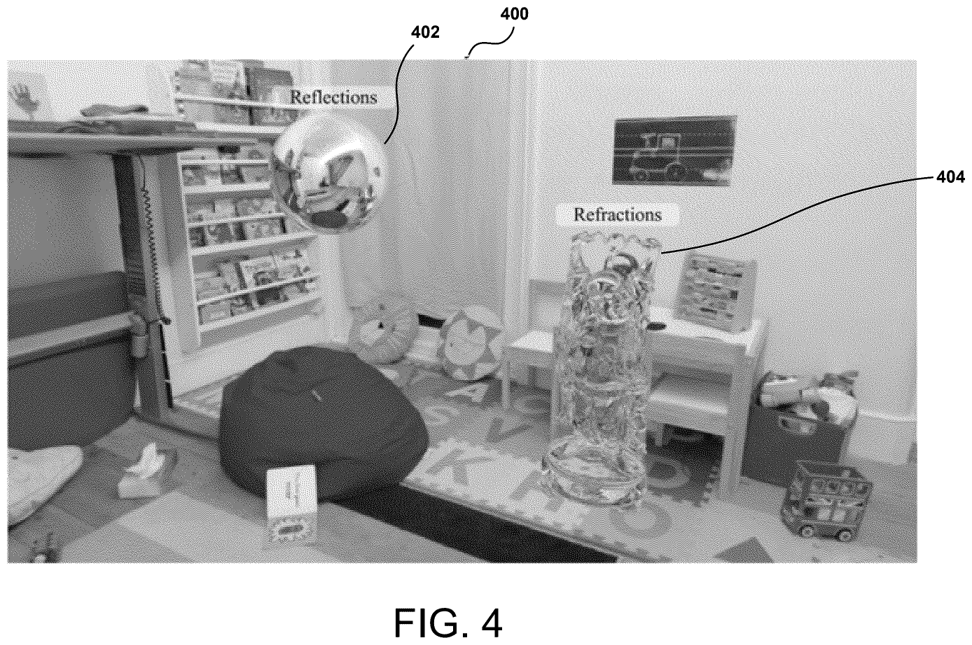

As mentioned, such a system can also be used to account for secondary rays and lighting effects. As an example, FIG. 4 illustrates an example image 400 that includes a spherical mirrored object 402 that projects light in various secondary directions, as well as an irregularly-shaped glass object 404 that can refract or otherwise bend light rays as they are incident, transmitted through, and then propagated from the surfaces and body of the object. An approach in accordance with one embodiment can represent these secondary rays and lighting effects using a similar 3DGRT-based approach. Rendering formulations of 3DGS and 3DGRT differ, to a large extent, in terms of (i) determining which particles contribute to which pixels, (ii) the order of particle evaluation, and (iii) the computation of the particles' responses. In the disclosure above, it was mentioned that these differences can be reduced to arrive at a common 3D representation that can be both rasterized and traced. While some discrepancies naturally remain, approaches disclosed herein were observed to achieve much better alignment to 3DGRT than 3DGS or other such approaches.

Aligning a rendering formulation as disclosed herein to a 3DGRT-based approach allows for performance of hybrid rendering by rasterizing the primary and tracing the secondary rays within the same representations. Specifically, the primary ray intersections with the scene can be computed first, and these primary rays can then be rendered using a disclosed splatting method by discarding Gaussian hits that fall behind a ray's closest intersection. Secondary rays can then be computed and traced using a technique such as 3DGRT. Such a hybrid rendering technique can achieve most of the complex visual effects (such as reflections and refractions) that might otherwise only be possible with ray tracing (or a similar such approach).

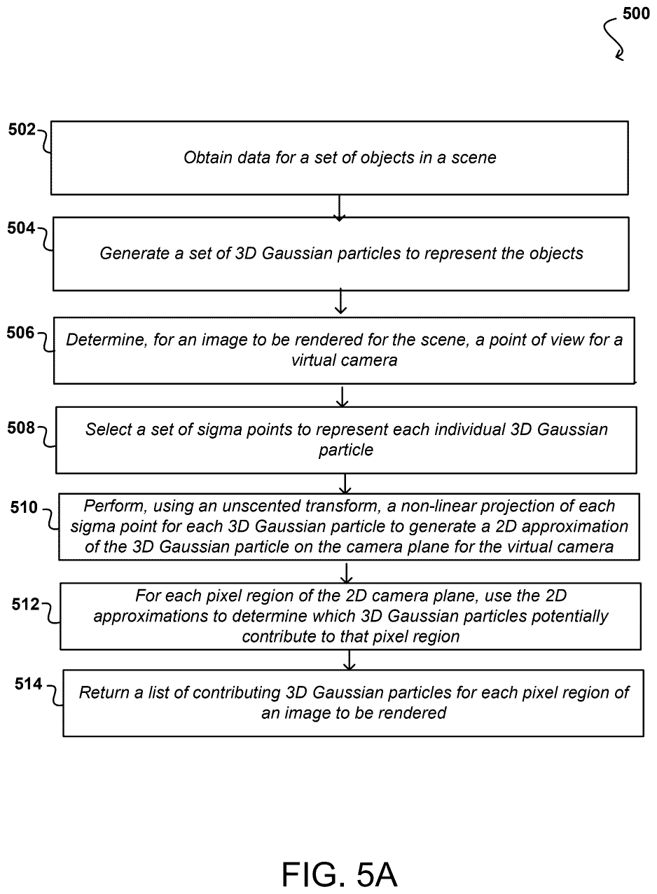

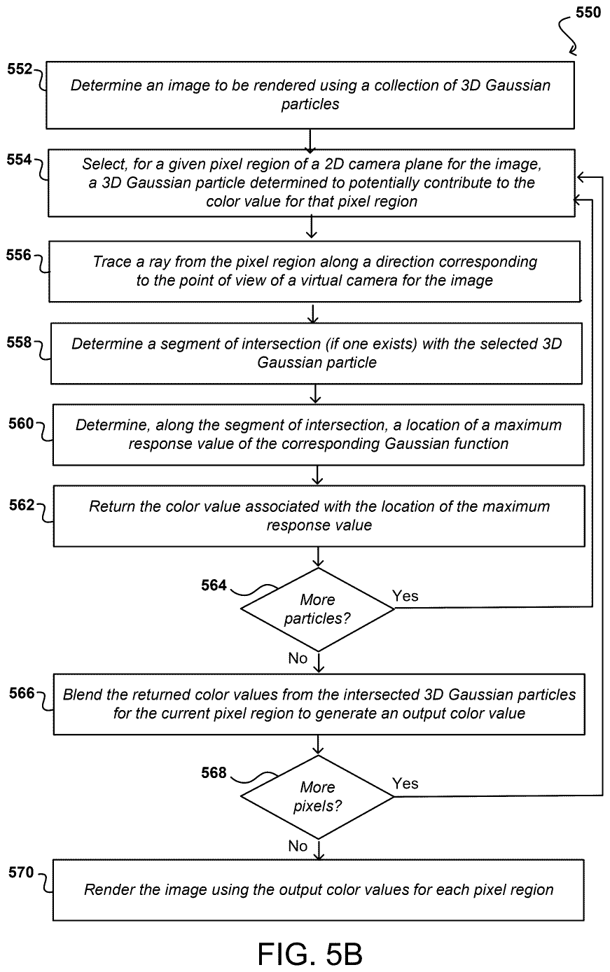

FIG. 5A illustrates an example process 500 that can be performed to determine which 3D Gaussian particles are likely to contribute to each of a set of pixels of an image to be rendered, according to at least one embodiment. It should be understood that for this and other such processes presented herein, there may be additional, fewer, or alternative steps performed in similar or alternative orders, or at least partially in parallel, within the scope of the various embodiments unless otherwise specifically stated. Further, although this example will be discussed with respect to use of 3D Gaussian particles and pixel regions, there can be other 3D representations used to represent objects, and other image types of image regions used, within the scope of various embodiments. In this example process 500, data is obtained 502 for a set of objects in a scene. This data may include, for example, a set of images captured or generated for the objects from a limited number of viewpoints. A set of 3D Gaussian particles can be generated 504 to represent the objects, which helps to support the generation of novel view images for the objects in the scene. When an image is to be rendered for a scene, a point of view for a virtual camera can be determined 506. This includes information such as a relative distance and orientation of a virtual camera from the objects of the scene, to determine how to represent those images in the generated image.

As mentioned, the objects in the scene will be represented by a set of 3D Gaussian particles, but not each of these 3D Gaussian particles will contribute to each pixel of the image to be rendered. Because both the number of 3D Gaussian particles and the number of pixels can be quite large, it can be beneficial to avoid having to determine the contribution of 3D Gaussian particles with respect to each pixel. Accordingly, this process attempts to identify the subset of 3D Gaussian particles that are likely to contribute to each pixel, such that only those combinations can be evaluated. An unscented transform-based approach can be used to project each 3D Gaussian particle onto a 2D camera plane for the virtual camera, where a set of sigma points is selected 508 for each 3D Gaussian particle. The sigma points can be selected based on factors such as location and covariance. A non-linear projection of these sigma points can be performed 510 to generate a 2D approximation of each 3D Gaussian particle on the camera plane. For each pixel region of the 2D camera plane, these 2D approximations (based on the projected sigma points) can be used 512 to determine the 3D Gaussian particles that (at least potentially) contribute to that pixel region, so that the other 3D Gaussian particles do not need to be evaluated for that given pixel region. A list (or set or other grouping) of contributing 3D Gaussian particles for each pixel region can then be returned 514 for use in generating the target image with the determined (or otherwise specified) point of view.

FIG. 5B illustrates an example process 550 that can be performed to render an image based in part on 3D Gaussian particles determined to potentially contribute to individual pixels of the image, according to at least one embodiment. In this example, an image to be rendered is determined 552 (or otherwise specified), where the image is to be rendered using a collection of 3D Gaussian particles. For individual pixel regions of the image to be rendered, a 3D Gaussian particle can be selected 554 for evaluation that was previously identified to potentially contribute to the color value of that pixel region, such as by using a process such as that described with respect to FIG. 5B. A ray can be traced 556 (or other non-linear projection made) for the pixel region along a direction corresponding to the point of view of a virtual camera for the image. A segment of intersection between the ray and the 3D Gaussian particle can be determined 558 (if one exists). A location of a maximum response value for the corresponding Gaussian function can be determined 560 along the segment. The color value associated with that point of maximum response can be returned 562 for that 3D Gaussian particle. If it is determined 564 that there are more contributing particles to be evaluated for a given pixel region, then the process can continue for the next 3D Gaussian particle. If all potentially contributing 3D Gaussian particles have been evaluated for a given pixel region, then the returned color values from the intersected 3D Gaussian particles can be blended 566 to generate an output color value for that pixel region. If it is determined 568 there are more pixels to be evaluated, then the process can continue for the next pixel region. It should be understood that evaluations for various pixel regions can also be performed at least partially in parallel, where appropriate. If all pixel regions have been evaluated for the image, then the image can be rendered 570 (or otherwise generated) using the output color values determined for each pixel region. As mentioned, the generated image can be a standalone image, an image of an image sequence or stream, a frame of video content, a portion of a projection or holographic display, or other such instance of visual content.

As mentioned, such a process can benefit from the use of an unscented transform, rather than, for example, a non-linear projection function as used in 3DGS. Such usage allows for the support of distorted cameras, as well as support time-dependent effects such as rolling shutter. Such an approach also supports hybrid rendering and unlocks secondary rays for lighting effects. Such an approach has also been observed to be significantly more efficient than at least certain prior ray tracing-based approaches. While primary use cases are directed to animation, gaming, and simulations, advantages can be obtained in other fields of use as well, as may relate to autonomous driving and robotics, where training and rendering with distorted cameras is essential. Such approaches can also support uses related to inverse rendering and relighting.

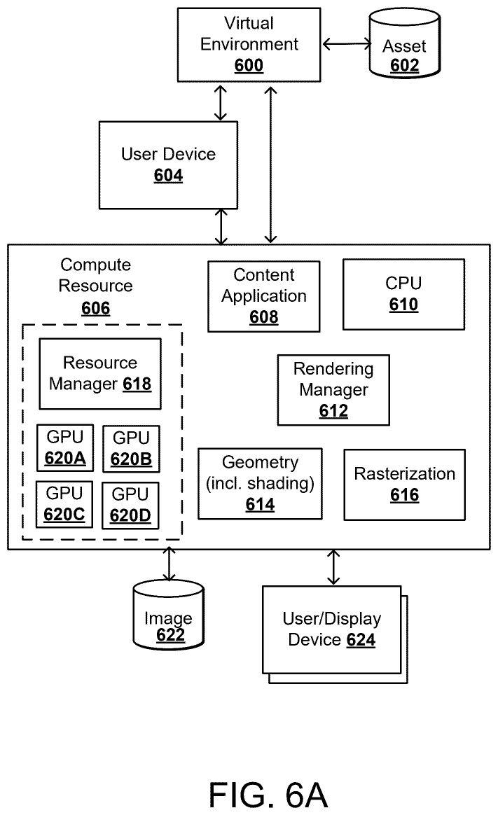

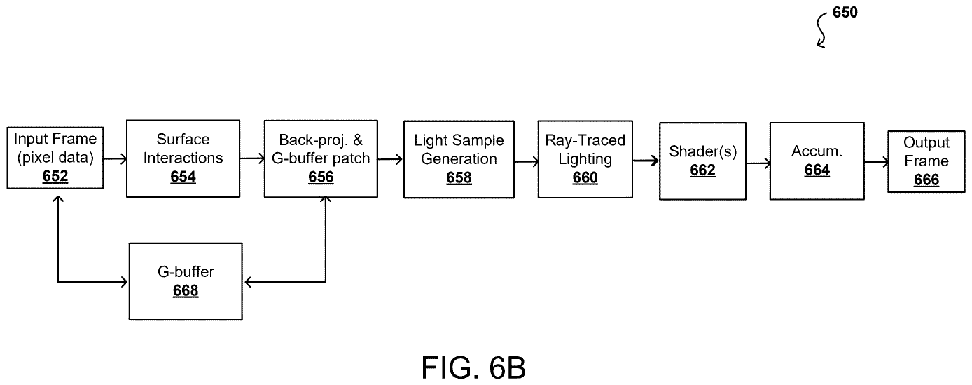

As mentioned, 3D Gaussian particles can be used to represent objects in a scene, and those 3D Gaussian particles can be used to render images with various views of that scene. FIG. 6A illustrates an example system for rendering such an image, video frame, or other instance of image-related content in accordance with at least one embodiment. Such a system can include or incorporate functionality as presented herein to allow for the consideration of a portion of the surface geometry of a model that has an unobstructed visual path to a camera-accessible region, among other such options. In this example, an image is to be rendered for a scene in a virtual environment 600, although images can be rendered for semi-virtual or real environments as well using such a system. The virtual environment 600 may include geometry and other data representative of shapes or objects in the environment, such as three-dimensional (3D) objects that are representative, or are to be included in, a scene that occurs within the environment, as may include foreground objects such as people or vehicles, or background objects such as roads and buildings, among other such options. In at least some embodiments, at least some of the content for the scene may also be obtained from an asset repository 602, or other such location, which can contain content—such as geometry, textures, and density data—that can be used to render the scene. In at least some embodiments or instances, there can be a user device 604 running a content generation or management application that can allow a user to select assets 602 and at least a relevant portion of the virtual environment 600 to use in rendering the scene. The user device 604 can also allow a user to control aspects of the image to be rendered, such as the location or pose of an object in the scene, as well as a viewpoint and other parameters of a virtual camera to be used to render an image of the virtual environment 600.

In this example, at least one compute resource 606 is used to perform the rendering. This resource may correspond to one or more servers, for example, that may be located locally or across at least one network, among other such options. In some embodiments, the rendering may instead be at least partially performed on the user device 604. The compute resource 606 may obtain or receive data to be used for the rendering, as may include geometry, texture, and density data for the virtual environment or assets, as well as information about the locations and poses of those objects in the scene and parameters of a virtual camera to be used to determine the view of the scene to be rendered. This information may be received to a content application 608, for example, that may be executing on a central processing unit (CPU) 610 of the compute resource that is responsible for tasks such as collecting data, causing an image to be rendered, and performing any formatting or encoding of a produced image, among other such operations. The content application can work with a rendering manager 612, for example, which can be responsible for coordinating operations of a rendering pipeline executing on the compute resource 606, as may include modules 614, 616 or processes responsible for tasks such as geometry related tasks (including lighting and shading tasks) and rasterization, among other such tasks. In at least one embodiment, a rendering manager 612 can generate a digital reconstruction of the virtual environment 600. In at least some embodiments, at least some of these rendering tasks may be performed using one or more GPUs 620A-D of the compute resource, as well as potentially one or more processors or compute instances (physical or virtual) of one or more other compute resources.

A task such as light transport simulation (e.g., ray tracing, path tracing, ray marching, etc.) or volumetric sampling can be performed using a single processor, such as a single GPU, or can have operations distributed across multiple GPUs 620A-D). In this example, there can be a pool or set of GPUs 620A-D, and a resource manager 618 can be at least partially responsible for allocating a GPU to perform the processing for an operation. If it is desired or beneficial to use more than one GPU, then the resource manager 618 can allocate one or more GPUs having the appropriate capacity or capabilities. This can include allocating a number of GPUs indicated in a request, or determining a number of GPUs to allocate based in part on the request. In some embodiments, the resource manager may also be able to monitor an available bandwidth or memory in order to determine which and how many GPUs to allocate, such as where having high bandwidth capacity can allow operations to be spread across a greater number of GPUs, where bandwidth impact due to forwarding ray information will not be as critical, while having a bandwidth constrained system may cause the resource manager to attempt to allocate as few GPUs as possible in order to attempt to reduce the number of forwarding messages required.

In at least one embodiment, a partitioning of data can be performed by a rendering manager 612, for example, and the assigning of data to different processors can be performed by a resource manager 618 of the system. The resource manager can receive information from the rendering component, and can select appropriate processors from a pool of available processors 620 or processor capacity. In some embodiments, the rendering application can choose the partitioning, while in other embodiments the renderer may have no control over the data partitioning, which may be done by a separate management component (not illustrated in FIG. 6A).

FIG. 6B illustrates an example image generation pipeline 650 that can be used in a system—such as that illustrated in FIG. 6A—to render one or more images, such as video frames in a sequence for a specific scene and/or domain. In this example, pixel data 652 for a current frame to be rendered (as may include G-buffer data for primary surfaces) can be received as input to a reflections and refractions component 654 of a rendering system. Reflections and refractions component 654 can use this data to attempt to determine data for any determined reflections and/or refractions in the pixel data, and can provide this data to a back-projection and G-buffer patching component 656, which can perform back-propagation as discussed herein to locate corresponding points for those reflections and refractions, and use this data to patch the G-buffer 668, which can provide updated input for a subsequent frame to be rendered. The data can then be provided to a light sample generation component 658 to perform light sampling, a ray-traced lighting component 660 to perform ray-traced lighting, and one or more shaders 662, which can set the pixel colors for the various pixels of the frame based at least in part upon the determined lighting information (along with other information such as color, texture, and so on). The results can be accumulated by an accumulation module 664 or component for generating an output frame 666 of a desired size, resolution, or format.

In at least one embodiment, a shader 662 can perform the backward projection step. Once a backward projection pass has finished, and gradient surface parameters have been patched into the current G-buffer, a renderer can execute the lighting passes. Using information from the lighting passes and the lighting results from the previous frame, gradients can be computed then filtered and used for history rejection. Such an approach can be used to compute robust temporal gradients between current and previous frames in a temporal denoiser for ray-traced renderers. Such a backward projection-based approach can also work through reflections and refractions, and can work with rasterized G-buffers. Previous approaches for backward projection omitted any G-buffer patching and relied on the raw current G-buffer samples instead, which also results in false positive gradients. Patching the surface parameters can eliminate false positives in the vast majority of cases, making the denoised image very stable yet still quickly reacting to lighting changes. Once the backward projection pass is finished, and gradient surface parameters have been patched into the current G-buffer, a renderer can execute the lighting passes. Using the information from the lighting passes and the lighting results from the previous frame, the gradients are computed then filtered and used for history rejection. NeRFs or other machine learning models can be used at various stages of such a pipeline, for use in inferring aspects of the rendering process.

Aspects of various approaches presented herein can be lightweight enough to execute in various locations, such as on a device such as a client device that include a personal computer or gaming console, in real time. Such processing can be performed on, or for, content that is generated on, or received by, that client device or received from an external source, such as streaming data or other content received over at least one network from a cloud server or third party service, among other such options. In some instances, at least a portion of the processing, generation, compositing, and/or determination of this content may be performed by one of these other devices, systems, or entities, then provided to the client device (or another such recipient) for presentation or another such use.

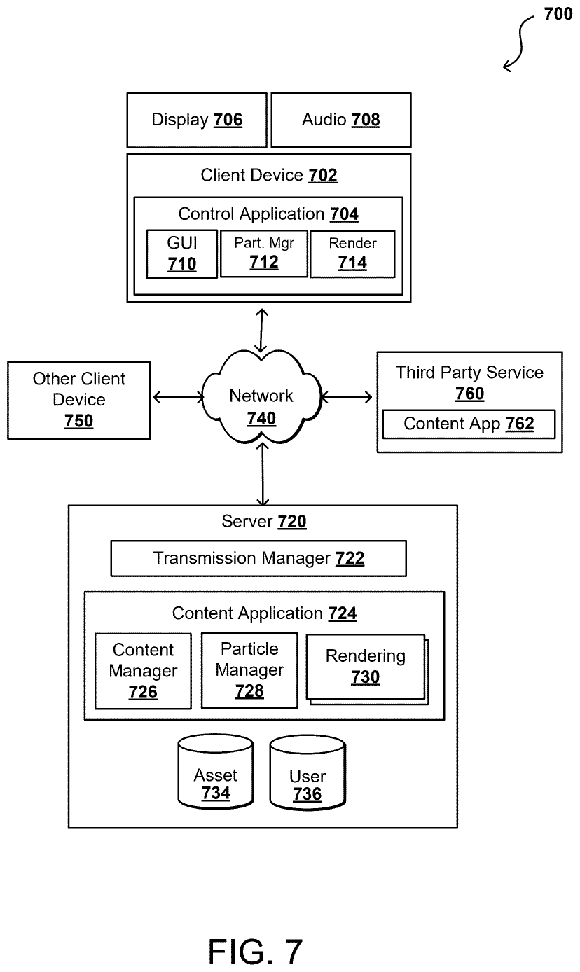

As an example, FIG. 7 illustrates an example network configuration 700 that can be used to provide, generate, modify, encode, process, and/or transmit image data or other such content. In at least one embodiment, a client device 702 can generate or receive data for a session using components of a content application 704 on client device 702 and data stored locally on that client device. In at least one embodiment, a content application 724 executing on a server 720 (e.g., a cloud server or edge server) may initiate a session associated with at least one client device 702, as may utilize a session manager and user data stored in a user database 736, and can cause content such as one or more digital assets (e.g., implicit and/or explicit object representations, such as models or meshes) from an asset repository 734 to be determined by a content manager 726. A content manager 726 may work with a rendering module 730 to generate or select objects, digital assets, or other such content to be represented in an image to be rendered. Views of these objects can be rendered by the rendering module 730 and provided for presentation via the client device 702. In this example, the content application 724 includes a mesh generator 728 that can generate mesh representations of objects using point cloud or other such object data, which can be provided to a rendering module 730 in order to render a view of a digital object. In at least one embodiment, the content application 724 an work with one or more encoders, transcoders, and/or compressors that can perform tasks such as encoding, decoding, compression, and/or decompression of a texture, image, or other such asset or instance of content, where different compressions or encodings may be beneficial for different operations, such as for storage versus processing. At least a portion of the rendered and/or compressed content may be transmitted to the client device 702 using an appropriate transmission manager 722 to send by download, streaming, or another such transmission channel. An encoder may be used to encode and/or compress at least some of this data before transmitting to the client device 702. In at least one embodiment, the client device 702 receiving such content can provide this content to a corresponding content application 704, which may also or alternatively include a graphical user interface 710, mesh generator 712, and rendering module 714 for use in providing, synthesizing, rendering, compositing, modifying, or using content for presentation (or other purposes) on or by the client device 702. A decoder may also be used to decode data received over the network(s) 740 for presentation via client device 702, such as image or video content through a display 706 and audio, such as sounds and music, through at least one audio playback device 708, such as speakers or headphones. In at least one embodiment, at least some of this content may already be stored on, rendered on, or accessible to client device 702 such that transmission over network 740 is not required for at least that portion of content, such as where that content may have been previously downloaded or stored locally on a hard drive or optical disk. In at least one embodiment, a transmission mechanism such as data streaming can be used to transfer this content from server 720, or user database 736, to client device 702. In at least one embodiment, at least a portion of this content can be obtained, enhanced, and/or streamed from another source, such as a third party service 760 or other client device 750, that may also include a content application 762 for generating, enhancing, or providing content. In at least one embodiment, portions of this functionality can be performed using multiple computing devices, or multiple processors within one or more computing devices, such as may include a combination of CPUs and GPUs.

In at least one embodiment, components such as those illustrated in FIG. 7 can be used to offer aspects of various embodiments as one or more services, such as a Web service or cloud service, for example, that may be accessed using an appropriate API or address. Such a process may be relatively slow to perform, so having a streaming service process mesh in an asset pipeline (e.g., during game development) may be useful. This could happen once and the resulting clustering is saved for distribution in a game, so the clustering algorithm is not directly part of the rendering, but something pre-computed.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Data Center

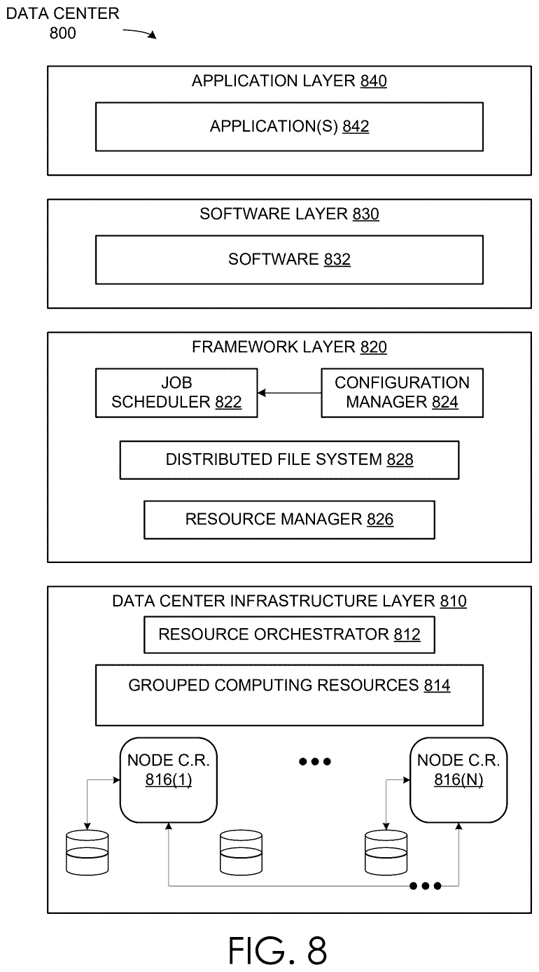

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Such components can be used to support distorted cameras in scene reconstruction using unscented transforms with 3D Gaussian particle representations.

### Computer Systems

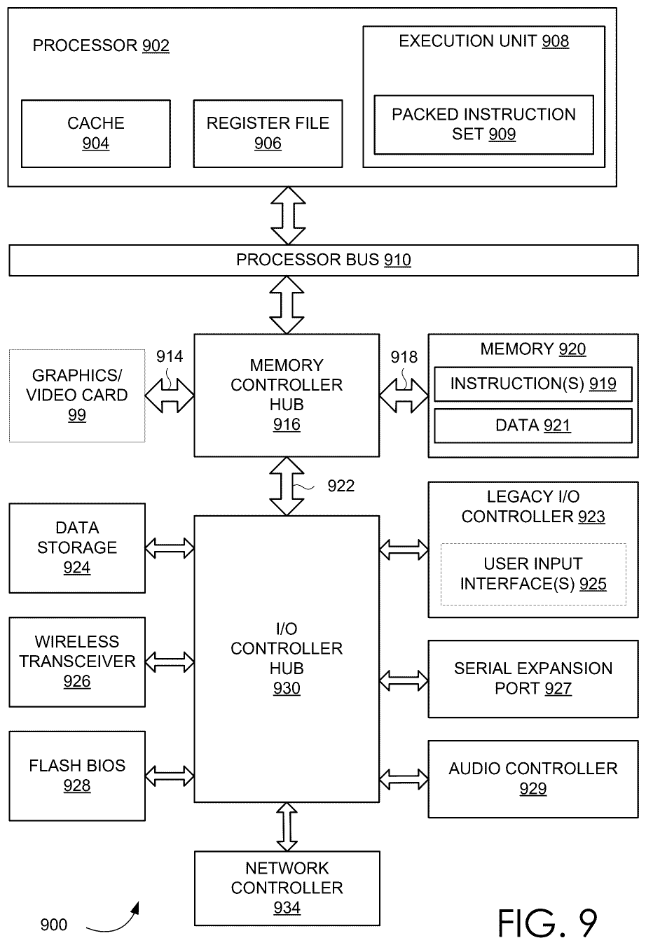

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Such components can be used to support distorted cameras in scene reconstruction using unscented transforms with 3D Gaussian particle representations.

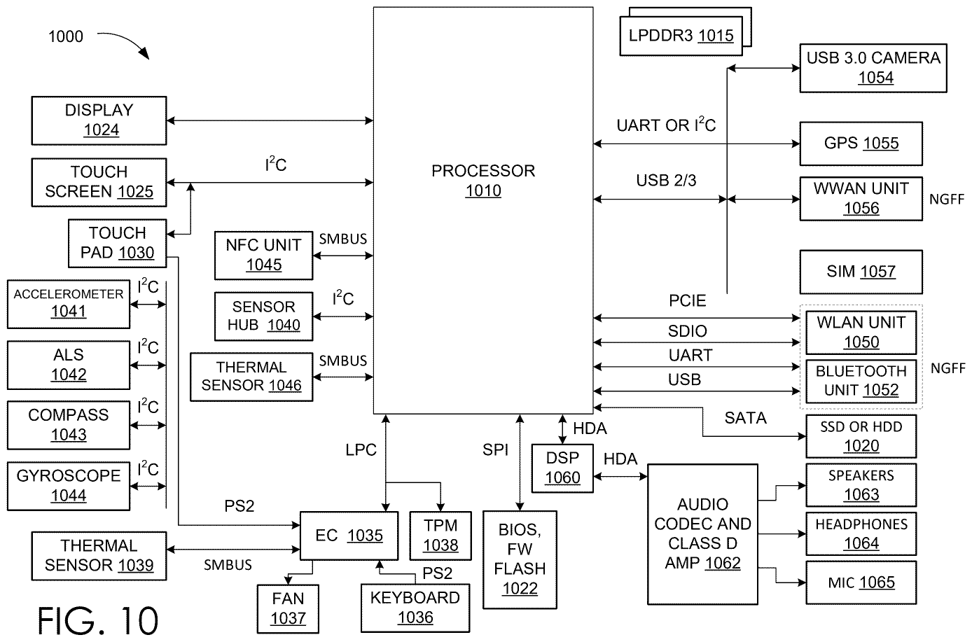

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speaker 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1064 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Such components can be used to support distorted cameras in scene reconstruction using unscented transforms with 3D Gaussian particle representations.

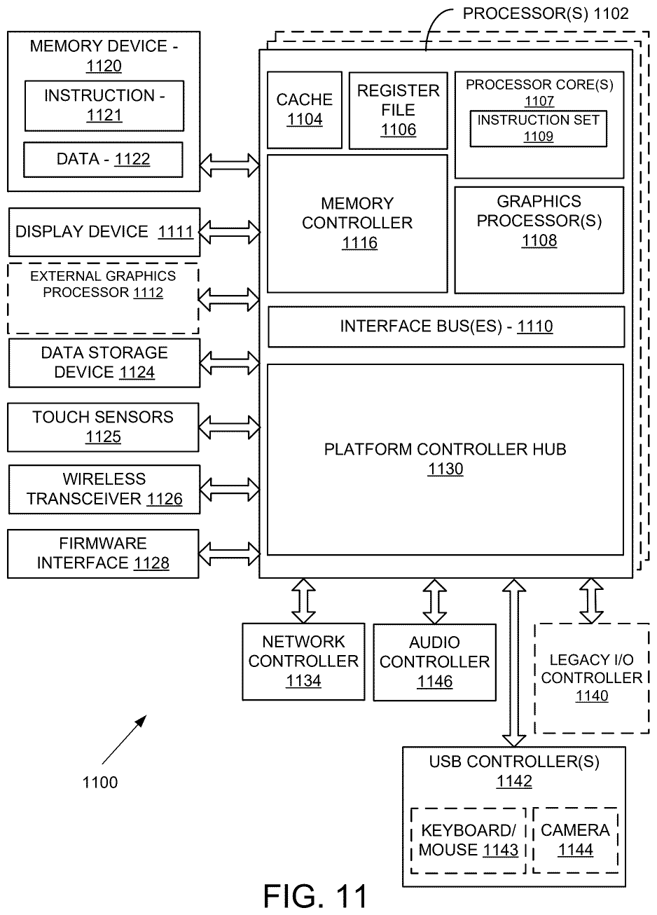

FIG. 11 is a block diagram of a processing system, according to at least one embodiment. In at least one embodiment, system 1100 includes one or more processors 1102 and one or more graphics processors 1108, and may be a single processor desktop system, a multiprocessor workstation system, or a server system having a large number of processors 1102 or processor cores 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, system 1100 can also include, couple with, or be integrated within a wearable device, such as a smart watch wearable device, smart eyewear device, augmented reality device, or virtual reality device. In at least one embodiment, system 1100 is a television or set top box device having one or more processors 1102 and a graphical interface generated by one or more graphics processors 1108.

In at least one embodiment, one or more processors 1102 each include one or more processor cores 1107 to process instructions which, when executed, perform operations for system and user software. In at least one embodiment, each of one or more processor cores 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor cores 1107 may each process a different instruction set 1109, which may include instructions to facilitate emulation of other instruction sets. In at least one embodiment, processor core 1107 may also include other processing devices, such a Digital Signal Processor (DSP).

In at least one embodiment, processor 1102 includes cache memory 1104. In at least one embodiment, processor 1102 can have a single internal cache or multiple levels of internal cache. In at least one embodiment, cache memory is shared among various components of processor 1102. In at least one embodiment, processor 1102 also uses an external cache (e.g., a Level-3 (L3) cache or Last Level Cache (LLC)) (not shown), which may be shared among processor cores 1107 using known cache coherency techniques. In at least one embodiment, register file 1106 is additionally included in processor 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor 1102 and other components in system 1100. In at least one embodiment, interface bus 1110, in one embodiment, can be a processor bus, such as a version of a Direct Media Interface (DMI) bus. In at least one embodiment, interface 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instructions 1121 for use when one or more processors 1102 executes an application or process. In at least one embodiment, memory controller 1116 also couples with an optional external graphics processor 1112, which may communicate with one or more graphics processors 1108 in processors 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controllers 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Such components can be used to support distorted cameras in scene reconstruction using unscented transforms with 3D Gaussian particle representations.

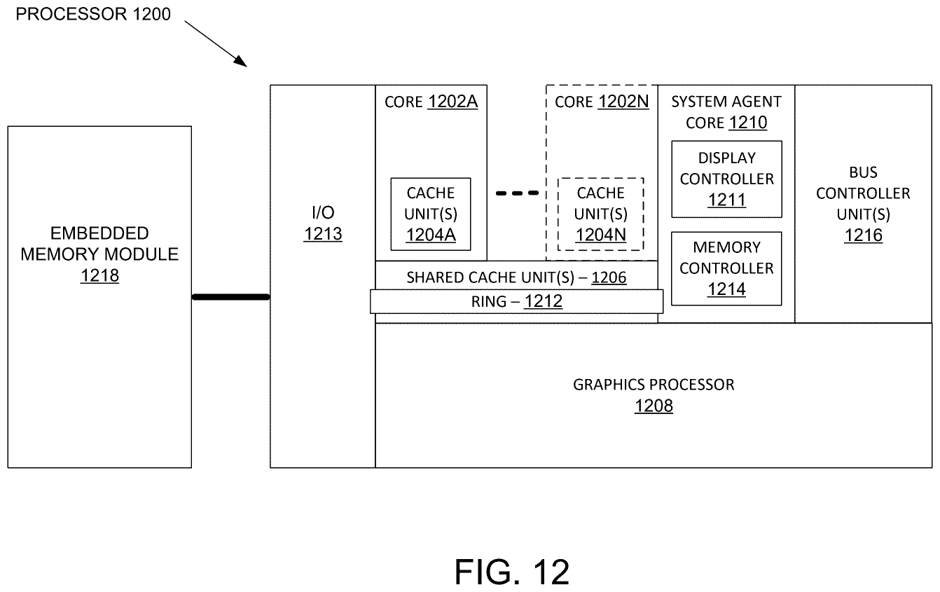

FIG. 12 is a block diagram of a processor 1200 having one or more processor cores 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor cores 1202A-1202N includes one or more internal cache units 1204A-1204N. In at least one embodiment, each processor core also has access to one or more shared cached units 1206.

In at least one embodiment, internal cache units 1204A-1204N and shared cache units 1206 represent a cache memory hierarchy within processor 1200. In at least one embodiment, cache memory units 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1206 and 1204A-1204N.

In at least one embodiment, processor 1200 may also include a set of one or more bus controller units 1216 and a system agent core 1210. In at least one embodiment, one or more bus controller units 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor cores 1202A-1202N include support for simultaneous multi-threading. In at least one embodiment, system agent core 1210 includes components for coordinating and operating cores 1202A-1202N during multi-threaded processing. In at least one embodiment, system agent core 1210 may additionally include a power control unit (PCU), which includes logic and components to regulate one or more power states of processor cores 1202A-1202N and graphics processor 1208.

In at least one embodiment, processor 1200 additionally includes graphics processor 1208 to execute graphics processing operations. In at least one embodiment, graphics processor 1208 couples with shared cache units 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with ring interconnect 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor cores 1202A-1202N and graphics processor 1208 use embedded memory modules 1218 as a shared Last Level Cache.

In at least one embodiment, processor cores 1202A-1202N are homogenous cores executing a common instruction set architecture. In at least one embodiment, processor cores 1202A-1202N are heterogeneous in terms of instruction set architecture (ISA), where one or more of processor cores 1202A-1202N execute a common instruction set, while one or more other cores of processor cores 1202A-1202N executes a subset of a common instruction set or a different instruction set. In at least one embodiment, processor cores 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Such components can be used to support distorted cameras in scene reconstruction using unscented transforms with 3D Gaussian particle representations.

Various embodiments can be described by the following clauses:
1. A system, comprising:
one or more processing units to:
project, onto a two-dimensional (2D) image plane using a non-linear projection function, a set of representative points for a plurality of three-dimensional (3D) Gaussian particles, the 3D Gaussian particles representing one or more objects in a 3D environment;
determine, using the projected set of representative points, a subset of the 3D Gaussian particles with a probability, above a threshold, of contributing to pixel values for individual pixels of an image to be rendered with respect to the 3D environment;
determine, for at least one of the individual pixels of the image, a point of maximum response along a segment of intersection between a projected ray and each respective 3D Gaussian particle of the corresponding subset; and
generate image data using pixel values determined by blending contributing values, corresponding to the points of maximum response for at least one 3D Gaussian particle intersecting the projected ray for the corresponding individual pixels.
2. The system of clause 1, wherein the one or more processing units are further to:
generate the set of 3D Gaussian particles to approximate surfaces of the one or more objects in the 3D environment.
3. The system of clause 1, wherein the non-linear projection function corresponds to an unscented transform function.
4. The system of clause 1, wherein the one or more processing units are further to:
select the set of representative points for individual 3D Gaussian particles as a set of sigma points able to be independently projected onto the 2D image plane.
5. The system of clause 4, wherein the one or more processing units are further to:
select the sigma points based in part on position and covariance.
6. The system of clause 1, wherein the 3D Gaussian particles comprise volumetric, fuzzy 3D Gaussian splatting particles.
7. The system of clause 1, wherein the image data is generated using a rasterization process.
8. The system of clause 1, wherein the image to be rendered includes one or more representations of the one or more objects as the objects would appear if captured by a distorted camera or represented using secondary imaging effects.
9. The system of clause 1, wherein the one or more processing units are further to:
blend at least two of the contributing values for a pixel location using hybrid transparency blending.
10. The system of clause 1, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.
11. A rendering system including one or more processors to determine pixel values for an image to be rendered by, in part, blending two or more contributing values corresponding to points of maximum response determined from intersections of projected rays with a selected subset of 3D Gaussian particles, the selected subset determined to contribute to respective pixel locations of the image based in part upon non-linear projections of representative points of the 3D Gaussian particles onto a 2D image plane.
12. The rendering system of clause 11, wherein the one or more processors are further to:
generate a set of the 3D Gaussian particles to approximate surfaces of one or more objects in a 3D environment.
13. The rendering system of clause 11, wherein the non-linear projection function corresponds to an unscented transform.
14. The rendering system of clause 11, wherein the one or more processors are further to:
select the representative points for individual 3D Gaussian particles as a set of sigma points able to be independently projected onto the 2D image plane.
15. The rendering system of clause 14, wherein the one or more processors are further to:
select the sigma points based in part on position and covariance.
16. The rendering system of clause 11, wherein the rendering system is included in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.
17. At least one processor, comprising:
processing circuitry to:
project, onto a two-dimensional (2D) image plane using a non-linear projection function, a set of representative points for a plurality of three-dimensional (3D) Gaussian particles, the 3D Gaussian particles representing one or more objects in a 3D environment;
determine, using the projected points, a subset of the 3D Gaussian particles that have a probability of contributing to pixel values for individual pixels of an image to be rendered with respect to the 3D environment;
determine, for the individual pixels of the image, a point of maximum response along a segment of intersection between a projected ray and each respective 3D Gaussian particle of the corresponding subset; and
generate image data using pixel values determined by blending contributing values, corresponding to the points of maximum response for each 3D Gaussian particle intersecting the projected ray for the corresponding individual pixels.
18. The at least one processor of clause 17, wherein the non-linear projection function corresponds to an unscented transform function.
19. The at least one processor of clause 17, wherein the processing circuitry is further to:
select the set of representative points for individual 3D Gaussian particles as a set of sigma points able to be independently projected onto the 2D image plane.
20. The at least one processor of clause 17, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system, comprising:
one or more processing units to:
project, onto a two-dimensional (2D) image plane using a non-linear projection function, a set of representative points for a plurality of three-dimensional (3D) Gaussian particles, the 3D Gaussian particles representing one or more objects in a 3D environment;
determine, using the projected set of representative points, a subset of the 3D Gaussian particles with a probability, above a threshold, of contributing to pixel values for individual pixels of an image to be rendered with respect to the 3D environment;
determine, for at least one of the individual pixels of the image, a point of maximum response along a segment of intersection between a projected ray and each respective 3D Gaussian particle of the corresponding subset; and
generate image data using pixel values determined by blending contributing values, corresponding to the points of maximum response for at least one 3D Gaussian particle intersecting the projected ray for the corresponding individual pixels.

2. The system of claim 1, wherein the one or more processing units are further to:
generate the set of 3D Gaussian particles to approximate surfaces of the one or more objects in the 3D environment.

3. The system of claim 1, wherein the non-linear projection function corresponds to an unscented transform function.

4. The system of claim 1, wherein the one or more processing units are further to:
select the set of representative points for individual 3D Gaussian particles as a set of sigma points able to be independently projected onto the 2D image plane.

5. The system of claim 4, wherein the one or more processing units are further to:
select the sigma points based in part on position and covariance.

6. The system of claim 1, wherein the 3D Gaussian particles comprise volumetric, fuzzy 3D Gaussian splatting particles.

7. The system of claim 1, wherein the image data is generated using a rasterization process.

8. The system of claim 1, wherein the image to be rendered includes one or more representations of the one or more objects as the objects would appear if captured by a distorted camera or represented using secondary imaging effects.

9. The system of claim 1, wherein the one or more processing units are further to:
blend at least two of the contributing values for a pixel location using hybrid transparency blending.

10. The system of claim 1, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

11. A rendering system including one or more processors to determine pixel values for an image to be rendered by, in part, blending two or more contributing values corresponding to points of maximum response determined from intersections of projected rays with a selected subset of 3D Gaussian particles, the selected subset determined to contribute to respective pixel locations of the image based in part upon non-linear projections of representative points of the 3D Gaussian particles onto a 2D image plane.

12. The rendering system of claim 11, wherein the one or more processors are further to:
generate a set of the 3D Gaussian particles to approximate surfaces of one or more objects in a 3D environment.

13. The rendering system of claim 11, wherein the non-linear projection function corresponds to an unscented transform.

14. The rendering system of claim 11, wherein the one or more processors are further to:
select the representative points for individual 3D Gaussian particles as a set of sigma points able to be independently projected onto the 2D image plane.

15. The rendering system of claim 14, wherein the one or more processors are further to:
select the sigma points based in part on position and covariance.

16. The rendering system of claim 11, wherein the rendering system is included in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.

17. At least one processor, comprising:
processing circuitry to:
project, onto a two-dimensional (2D) image plane using a non-linear projection function, a set of representative points for a plurality of three-dimensional (3D) Gaussian particles, the 3D Gaussian particles representing one or more objects in a 3D environment;
determine, using the projected points, a subset of the 3D Gaussian particles that have a probability of contributing to pixel values for individual pixels of an image to be rendered with respect to the 3D environment;
determine, for the individual pixels of the image, a point of maximum response along a segment of intersection between a projected ray and each respective 3D Gaussian particle of the corresponding subset; and
generate image data using pixel values determined by blending contributing values, corresponding to the points of maximum response for each 3D Gaussian particle intersecting the projected ray for the corresponding individual pixels.

18. The at least one processor of claim 17, wherein the non-linear projection function corresponds to an unscented transform function.

19. The at least one processor of claim 17, wherein the processing circuitry is further to:
select the set of representative points for individual 3D Gaussian particles as a set of sigma points able to be independently projected onto the 2D image plane.

20. The at least one processor of claim 17, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative AI operations using a large language model (LLM);
a system using or deploying one or more inference microservices;
a system that incorporates one or more machine learning models deployed in a service or microservice along with an OS-level virtualization package (e.g., a container);
a collaborative content creation platform for 3D assets; or
a system implemented at least partially using cloud computing resources.
